(19) United States
(12) Patent Application Publication
(10) Pub. No.: US 2009/0059338 A1
(43) Pub. Date: Mar. 5, 2009

(54) OPTICAL SCANNING DEVICE AND IMAGE FORMING APPARATUS

(75) Inventor: Sasuke Endo, Kanagawa-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/198,297

(22) Filed: Aug. 26, 2008

Related U.S. Application Data
(60) Provisional application No. 60/969,145, filed on Aug. 30, 2007.

(51) Int. Cl. G02B 26/12

(52) U.S. Cl. 359/207.6; 359/216.1; 359/205.1

(57) ABSTRACT

An optical scanning device which corrects rotation distortion around an optical axis of the light beam is provided while a housing is reduced in site and is arranged to be manufactured accurately.

The optical scanning device includes a pre-deflection optical system that shapes a light beam emitted from a light source into a predetermined sectional shape, a polygon mirror that deflects an incident light beam with plural reflection surfaces arrayed in a rotating direction and scans the light beam on a scanning object, and a folding mirror that deflects the light beam, which is shaped by the pre-deflection optical system, with a reflection surface and guides the light beam to the reflection surfaces of the polygon mirror. The reflection surfaces of the polygon mirror and the reflection surface of the folding mirror have a position relation for correcting rotation distortion around an optical axis of the light beam, which is shaped by the pre-deflection optical system, caused when the shaped light beam is deflected by the folding mirror.

### BACKGROUND OF THE INVENTION

1. Field of the Invention

The present invention relates to an optical scanning device used in a laser printer, a digital copying machine, and the like and an image forming apparatus using the same.

2. Description of the Related Art

In general, image process speed (paper conveying speed), image resolution, motor rotating speed of a polygon mirror (the number of revolutions of a polygon motor), and the number of surfaces of a polygon mirror have the following relation:

P×R=(25.4×Vr×N)÷60

where, P (mm/s) is process speed (paper conveying speed), R (dpi) is image resolution (the number of dots per one inch), Vr (rpm) is the number of revolutions of a polygon motor, and N is the number of surfaces of a polygon mirror.

According to the formula, printing speed and resolution are proportional to the number of surfaces of a polygon mirror and the number of revolutions of a polygon motor. Therefore, to realize high speed and high resolution, it is necessary to increase the number of surfaces of a polygon mirror or increase the number of revolutions of a polygon motor.

However, in a general under-illumination scanning optical system in the past, the width in a main scanning direction (a scanning direction of a polygon mirror, the same applies in the following description) of a light beam made incident on the polygon mirror is smaller than the width of a single reflection surface in the main scanning direction of the polygon mirror. Therefore, all incident beams are reflected. Abeam diameter on an image surface is proportional to an F number. When a focal length of a focusing optical system is represented as f and a main scanning beam diameter on a polygon mirror surface is represented as D, an F number Fn is represented as Fn=f/D. Therefore, when it is attempted to reduce the beam diameter on the image surface to improve an image quality, the main scanning beam diameter on the polygon mirror surface has to be increased. Consequently, when the number of polygon mirror surfaces is increased to realize high speed and high resolution, the polygon mirror needs to be increased in size.

When the polygon mirror increased in size is rotated at high speed, since a load on a motor of the polygon mirror is large, motor cost increases. Further, since large noise, vibration, and heat are generated, measures against the noise, the vibration, and the heat are necessary. Therefore, an over-illumination type scanning optical system is effective. In the over-illumination type scanning optical system, the width in the main scanning direction of a beam made incident on a polygon mirror is larger than the main scanning direction width of a polygon mirror surface. Therefore, since light beams are reflected on an entire reflection surface, even when the number of reflection surfaces is increased for an increase in speed and an increase in resolution and a beam diameter on the polygon mirror is secured, a polygon mirror diameter can be reduced. Therefore, since a load on the polygon motor can be reduced, the cost can also be reduced.

A diameter can be reduced and the number of surfaces can be increased in the polygon mirror of the over-illumination type scanning optical system. Therefore, a shape of the polygon mirror is closer to a circle and air resistance decreases. Moreover, even if the polygon mirror is rotated at high speed, noise, vibration, and heat can be reduced. By using the over-illumination scanning optical system, since noise and vibration are reduced, components as measures against the noise and the vibration such as glass can be eliminated or reduced. Therefore, the over-illumination scanning optical system can realize an effect of a reduction in cost. It is possible to realize high duty cycle with the over-illumination scanning optical system. The over-illumination scanning optical system is described in, for example, Laser Scanning Notebook (Leo Beiser, SPIE OPTICAL ENGINEERING PRESS).

On the other hand, in order to reduce a size of a housing and manufacture the housing accurately, it is desirable that respective optical components of a pre-deflection optical system (components configuring the pre-deflection optical system) are arranged parallel to a horizontal reference plane of the housing. However, when the light beam made incident on the polygon mirror tilts with respect to reflection surfaces of the polygon mirror, it is necessary to arrange the respective optical components of the pre-deflection optical system to be tilted with respect to a horizontal reference plane of the housing. Consequently, a size in a sub-scanning direction (a normal direction of the horizontal reference plane orthogonal to the main scanning direction) of the housing is increased in implementation.

When a folding mirror is arranged in the pre-deflection optical system to reduce a size of the housing, the optical components of the pre-deflection optical system cannot be arranged horizontally with respect to an identical plane. Therefore, there is a drawback (a problem) in that a manufacturing error tends to occur.

When the pre-deflection optical system is arranged horizontally with respect to the horizontal reference plane of the housing and the folding mirror provided upstream of the polygon mirror is arranged to tilt a reflection surface thereof along a direction corresponding to the main scanning direction and a direction corresponding to the sub-scanning direction with respect to a light beam made incident thereon, a phenomenon in which the light beam rotates around an optical axis of the light beam occurs.

### SUMMARY OF THE INVENTION

It is an object of an embodiment of the present invention to provide an optical scanning device and an image forming apparatus in which a housing is reduced in size and rotation (rotation distortion) of a coordinate around an optical axis of a light beam is corrected.

In order to solve the problem, an optical scanning device according to an aspect of the present invention includes a pre-deflection optical system that shapes a light beam emitted from a light source into a predetermined sectional shape, optical scanning means for deflecting an incident light beam with plural reflection surfaces arrayed in a rotating direction and scanning the light beams on a scanning object, and a folding mirror that deflects the light beam, which is shaped by the pre-deflection optical system, with a reflection surface and guides the light beam to the reflection surfaces of the optical scanning means. The reflection surfaces of the optical scanning means and the reflection surface of the folding mirror have a position relation for correcting rotation distortion around an optical axis of the light beam, which is shaped by the pre-deflection optical system, caused when the shaped light beam is deflected by the folding mirror.

An image forming apparatus according to an aspect of the present invention includes an optical scanning device including a pre-deflection optical system that shapes a light beam emitted from a light source into a predetermined sectional shape, optical scanning means for deflecting an incident light beam with plural reflection surfaces arrayed in a rotating direction and scanning the light beam on a scanning object, and a folding mirror that deflects the light beam, which is shaped by the pre-deflection optical system, with a reflection surface and guides the light beam to the reflection surfaces of the optical scanning means, the reflection surfaces of the optical scanning means and the reflection surface of the folding mirror having a position relation for correcting rotation distortion around an optical axis of the light beam, which is shaped by the pre-deflection optical system, caused when the shaped light beam is deflected by the folding mirror, a photoconductive member on which an electrostatic image is formed by the light beams scanned by the optical scanning device, and visualizing means for developing the electrostatic image formed on the photoconductive member.

### BRIEF DESCRIPTION OF THE DRAWINGS

FIG. 1 is a diagram showing a digital copying apparatus as an image forming apparatus having an optical scanning device according to an embodiment of the present invention;

FIG. 2 is a schematic block diagram showing an example of a driving circuit of the digital copying apparatus including the optical scanning device;

FIGS. 3A and 3B are schematic diagrams for explaining a configuration of the optical scanning device;

FIG. 4 is a diagram showing an example of a coordinate system for defining a shape of a lens surface;

FIG. 5 is a diagram showing parameters used in a definition formula for defining the shape of the lens surface;

FIG. 6 is a diagram showing an example of the definition formula for defining the shape of the lens surface; and

FIGS. 7A and 7B are perspective views for explaining that a coordinate of a light beam reflected by a folding mirror is rotated.

### DESCRIPTION OF THE EMBODIMENTS

An embodiment of the present invention will be hereinafter explained with reference to the accompanying drawings.

In the following explanation, a scanning direction of a polygon mirror is referred to as main scanning direction and a normal direction of a horizontal reference plane (a reference plane) described later is referred to as sub-scanning direction. The sub-scanning direction in an optical system corresponds to a conveying direction of a transfer material in an image forming apparatus. The main scanning direction indicates a direction perpendicular to the conveying direction on a surface of the transfer material. An image surface indicates the surface of the transfer material and a focusing surface indicates a surface on which a light beam is actually focused.

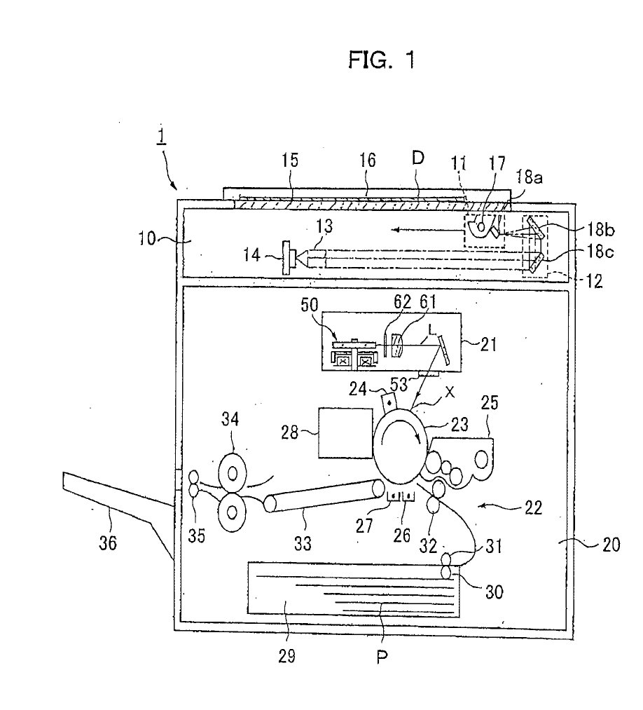

FIG. 1 shows a digital copying apparatus as an image forming apparatus having an optical scanning device according to this embodiment.

As shown in FIG. 1, a digital copying apparatus 1 includes a scanner unit 10 as image scanning means and a printer unit 20 as image forming means.

The scanner unit 10 includes a first carriage 11 formed to be movable in a direction of an arrow in FIG. 1, a second carriage 12 moved following the first carriage 11, an optical lens 13 that gives predetermined focusing properties to light from the second carriage 12, an photoelectric conversion element 14 that photoelectrically converts the light given with the predetermined focusing properties by the optical lens 13 and outputs an electric signal, an original stand 15 that holds an original D, and an original fixing cover 16 that presses the original D against the original stand 15.

In the first carriage 11, a light source 17 that illuminates the original D and a mirror 18a that reflects reflected light reflected from the original D, which is illuminated by light radiated by the light source 17, to the second carriage 12 are provided.

The second carriage 12 includes a mirror 18b that folds light transmitted from the mirror 18a of the first carriage 11 by 90° and a mirror 18c that further folds the light, which is folded by the mirror 18b, by 90°.

The original D placed on the original stand 15 is illuminated by the light source 17 and reflects reflected light in which light and shade of light corresponding to presence and absence of an image are distributed. The reflected light of the original D is made incident as an image information of the original D on the optical lens 13 via the mirrors 18a, 18b, and 18c.

The reflected light from the original D guided to the optical lens 13 is condensed on a light-receiving surface of the photoelectric conversion element (a CCD sensor) 14 by the optical lens 13.

When the start of image formation is inputted from a not-shown operation panel or external apparatus, the first carriage 11 and the second carriage 12 are temporarily moved to a home position, which is set to have a predetermined position relation with respect to the original stand 15, by the driving of a not-shown carriage driving motor. Thereafter, when the first carriage 11 and the second carriage 12 move at predetermined speed along the original stand 15, image information of the original D, i.e., image light reflected from the original D is sliced at predetermined width along a direction in which the mirror 18a is extended out, i.e., the main scanning direction, and reflected to the mirror 18b.

The image information is sequentially extracted in a unit of the width sliced by the mirror 18a with respect to a direction orthogonal to the direction in which the mirror 18a is extended out, i.e., the sub-scanning direction. All kinds of image information of the original D are guided to the CCD sensor 14. An electric signal outputted from the CCD sensor 14 is an analog signal. The electric signal is converted into a digital signal by a not-shown A/D converter and temporarily stored in a not-shown image memory as an image signal.

As described above, an image of the original D placed on the original stand 15 is converted by the CCD sensor 14 into, for example, an 8-bit digital image signal indicating light and shade of the image in a not-shown image processing unit line by line along the direction in which the mirror 18a is extended out.

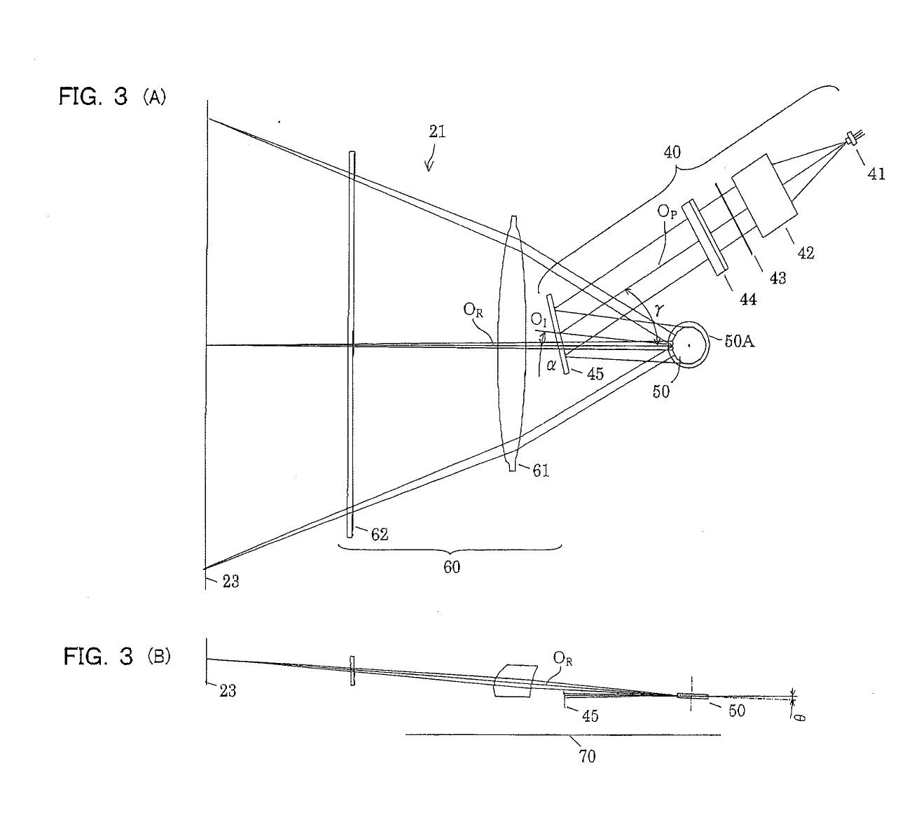

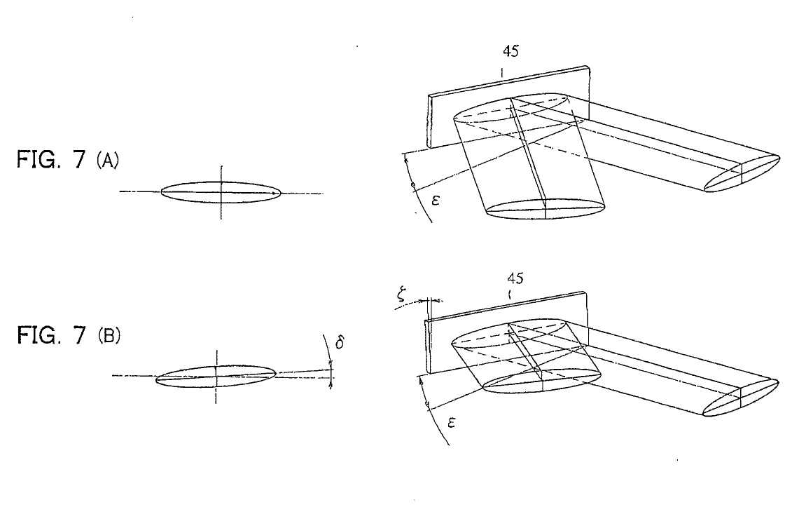

The printer unit 20 includes an optical scanning device 21 as an exposing device explained later with reference to FIGS. 3A and 3B and FIGS. 7A and 7B and an image forming unit 22 of an electrophotographic system that can form an image on a recording sheet P as an image forming medium.

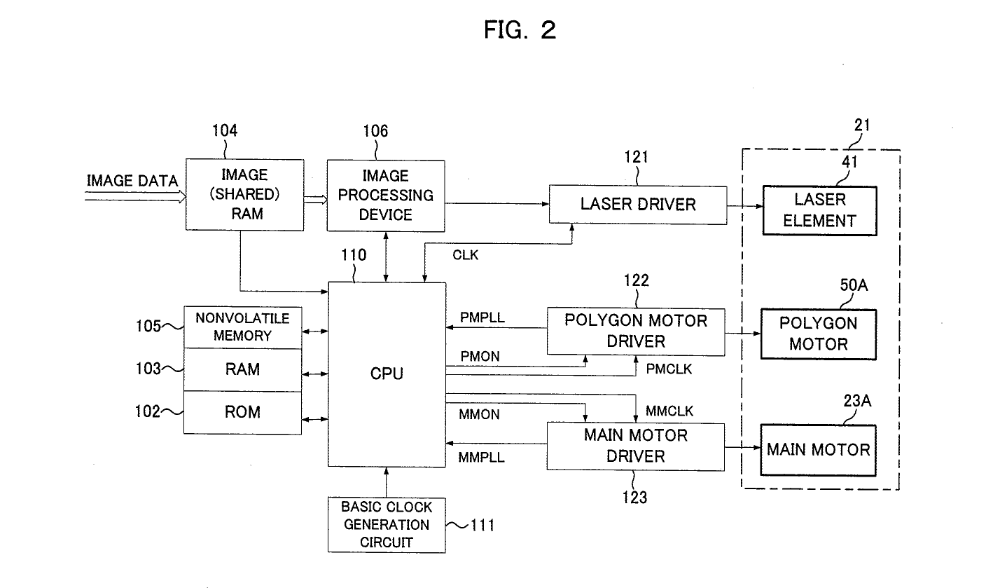

The image forming unit 22 includes a drum-like photoconductive member (hereinafter referred to as photoconductive drum) 23 that is rotated by a main motor 23A explained with reference to FIG. 2 such that an outer peripheral surface thereof moves at predetermined speed and on which a laser beam L is irradiated from the optical scanning device 21, whereby an electrostatic latent image corresponding to the image data, i.e., the image of the original D is formed. The image forming unit 22 also includes a charging device 24 that gives a surface potential of a predetermined polarity to the surface of the photoconductive drum 23 and a developing device 25 that selectively supplies a toner as a visualizing material to the electrostatic latent image on the photoconductive drum 23 formed by the optical scanning device 21 and develops the electrostatic latent image.

The image forming unit 22 also includes a transfer device 26 that gives a predetermined electric field to a toner image formed on an outer periphery of the photoconductive drum 23 by the developing device 25 and transfers the toner image onto the recording sheet P and a separating device 27 that releases the recording sheet P, on which the toner image is transferred by the transfer device 26, and the toner between the recording sheet P and the photoconductive drum 23 from electrostatic attraction to the photoconductive drum 23 and separates the recording sheet P and the toner (from the photoconductive drum 23). Moreover, the image forming unit 22 includes a cleaning device 28 that removes a transfer residual toner remaining on the outer peripheral surface of the photoconductive drum 23 and resets a potential distribution of the photoconductive drum 23 to a state before the surface potential is supplied by the charging device 24.

The charging device 24, the developing device 25, the transfer device 26, the separating device 27, and the cleaning device 28 are arrayed in order along an arrow direction in which the photoconductive drum 23 is rotated. The laser beam L from the optical scanning device 21 is irradiated on a predetermined position X on the photoconductive drum 23 between the charging device 24 and the developing device 25.

The image signal read from the original D by the scanner unit 10 is converted into a print signal by processing such as gradation processing for contour correction or half-tone display in the not-shown image processing unit. Moreover, the image signal read from the original D by the scanner unit 10 is converted into a laser modulation signal for changing light intensity of a laser beam irradiated from a light source 41 explained below of the optical scanning device 21 to intensity with which an electrostatic latent image can be recorded on the outer periphery of the photoconductive drum 23, to which the predetermined surface potential is given by the charging device 24, or intensity with which the electrostatic latent image is not recorded.

The light source 41 described below of the optical scanning device 21 is subjected to intensity modulation according to the laser modulation signal and emits light to record the electrostatic latent image in a predetermined position of the photoconductive drum 23 in association with predetermined image data. The light from the light source 41 is deflected in the main scanning direction, which is a direction identical with a direction of a scanning line of the scanner unit 10, by a polygon mirror 50 as a deflecting device explained below in the optical scanning device 21 and irradiated on the predetermined position X on the outer periphery of the photoconductive drum 23.

When the photoconductive drum 23 is rotated in the arrow direction at the predetermined speed, in the same manner as the movement of the first carriage 11 and the second carriage 12 of the scanner unit 10 along the original stand 15, the laser beam L from the light source 41 sequentially deflected by the polygon mirror 50 is exposed line by line on the outer periphery of the photoconductive drum 23 at predetermined intervals.

In this way, an electrostatic latent image corresponding to the image signal is formed on the outer periphery of the photoconductive drum 23.

The electrostatic latent image formed on the outer periphery of the photoconductive drum 23 is developed by the toner from the developing device 25 and conveyed to a position opposed to the transfer device 26 by the rotation of the photoconductive drum 23. The electrostatic latent image is transferred by the electric field from the transfer device 26 onto one recording sheet P that is extracted from a sheet cassette 29 by a paper feeding roller 30 and a separation roller 31 and supplied at timing aligned by aligning rollers 32.

The recording sheet P having the toner image transferred thereon is separated together with the toner by the separating device 27 and guided to a fixing device 34 by a conveying device 33.

The recording sheet P guided to the fixing device 34 is discharged to a tray 36 by paper discharge rollers 35 after the toner (the toner image) is fixed thereon by heat and pressure from the fixing device 34.

On the other hand, the photoconductive drum 23 after the toner image (the toner) is transferred onto the recording sheet P by the transfer device 26 is opposed to the cleaning device 28 as a result of the continued rotation. A transfer residual toner (a residual toner) remaining on the outer periphery thereof is removed by the cleaning device 28. The photoconductive drum 23 is reset to an initial state that is a state before the surface potential is supplied by the charging device 24. In this way, the photoconductive drum 23 is prepared for the next image formation.

It is possible to perform continuous image forming operations by repeating the process described above.

As described above, the image information of the original D set on the original stand 15 is scanned by the scanner unit 10 and the read image information is converted into a toner image by the printer unit 20 and outputted to the recording sheet P, whereby the original D is copied.

In the explanation of the image forming apparatus described above, the digital copying machine is an example of the image forming apparatus. However, the image forming apparatus may be, for example, a printer apparatus in which an image scanning unit is not present.

FIG. 2 is a schematic block diagram showing an example of a driving circuit of the digital copying apparatus 1 including the optical scanning device 21 shown in FIGS. 3A and 3B described later.

A ROM (read only memory) 102 in which predetermined operation rules and initial data are stored, a RAM 103 that temporarily stores inputted control data, and an image (shared) RAM 104 that stores image data from the CCD sensor 14 or image data supplied form an external apparatus and outputs image data to an image processing circuit described below are connected to a CPU 101 as a main control device.

A NVM (nonvolatile memory) 105 that stores, even when energization to the digital copying apparatus 1 is interrupted, data stored to that point with battery backup, an image processing device 106 that applies predetermined image processing to the image data stored in the image RAM 104 and outputs the image data to a laser driver explained below, and the like are also connected to the CPU 101.

A laser driver 121 that causes the light source 41 of the optical scanning device 21 to emit light, a polygon motor driver 122 that drives a polygon motor 50A that rotates the polygon mirror 50, a main motor driver 123 that drives a main motor 23A that drives, for example, the photoconductive drum 23 and a conveying mechanism for a sheet (a transfer material) incidental to the photoconductive drum 23, and the like are also connected to the CPU 101.

FIGS. 3A and 3B are schematic diagrams for explaining a configuration of the optical scanning device 21. FIG. 3A is a schematic plan view in which optical elements arrayed between the light source 41 and the photoconductive drum 23 (a scanning object) included in the optical scanning device 21 are viewed from a direction orthogonal to the main scanning direction, which is a direction parallel to a direction in which the laser beam L traveling from the polygon mirror 50 to the photoconductive drum 23 is scanned, and folding by the mirror is expanded for explanation. FIG. 3B is a schematic sectional view in a direction orthogonal to the direction shown in FIG. 3A, i.e., the main scanning direction and shows a horizontal reference plane 70 of a housing as a horizontal surface.

As shown in FIGS. 3A and 3B, the optical scanning device 21 includes a pre-deflection optical system 40 including, for example, the light source 41 that emits a 780 nm laser beam (light beam) L, a lens 42 that converts a sectional beam shape of the laser beam L emitted from the light source 41 into a sectional beam shape of converging light, an aperture 43 that limits a quantity of light (light beam width) of the laser beam L transmitted through the lens 42 to a predetermined quantity, and a cylindrical lens 44 to which positive power is given only in the sub-scanning direction in order to shape a sectional shape of the laser beam L, the quantity of light of which is limited by the aperture 43, into a predetermined sectional beam shape (in this embodiment, for example, an elliptical shape but the shape is not limited).

The optical scanning device 21 also includes a folding mirror 45 that deflects the laser beam L, which is shaped by the pre-deflection optical system, with a reflection surface and guides the laser beam L to reflection surfaces of the polygon mirror 50.

The optical scanning device 21 also includes the polygon mirror 50 (optical scanning means) that deflects the laser beam L guided by the folding mirror 45 with plural reflection surfaces arrayed in a rotating direction of the polygon mirror 50 and scans the laser beam L on the photoconductive drum 23 (the scanning object). The polygon mirror 50 is formed integrally with the polygon mirror motor 50A that rotates at the predetermined speed.

A focusing optical system 60 that focuses the laser beam L, which is continuously reflected on the respective reflection surfaces of the polygon mirror 50, substantially linearly along an axial direction of the photoconductive drum 23 is provided between the polygon mirror 50 and the photoconductive drum 23.

The focusing optical system 60 includes a focusing lens (usually called fθ lens) 61 and a dust-proof glass 62 that prevents a toner, dust, paper powder, or the like floating in the image forming unit 22 from sneaking into a not-shown housing. The focusing lens 61 irradiates the laser beam L, which is continuously reflected on the respective reflection surfaces of the polygon mirror 50, from one end to the other end in a longitudinal (axial) direction of the photoconductive drum 23 in the exposure position X shown in FIG. 1 while making a position of the irradiation on the photoconductive drum 23 and rotation angles of the respective reflection surfaces of the polygon mirror 50 proportional to each other. The focusing lens 61 can provide focusing properties to which a predetermined relation is given on the basis of an angle of rotation of the polygon mirror 50 such that the laser beam L has a predetermined sectional beam diameter in any position in the longitudinal direction on the photoconductive drum 23.

An optical path of the laser beam L from the light source 41 to the photoconductive drum 23 in the optical scanning device 21 is folded in the not-shown housing of the optical scanning device 21 by not-shown plural mirrors and the like. The focusing lens 61 and the not-shown mirrors may be integrated and formed as one unit by optimizing curvatures in the main scanning direction and the sub-scanning direction of the focusing lens 61 and an optical path between the polygon mirror 50 and the photoconductive drum 23.

In the optical scanning device 21 shown in FIGS. 3A and 3B, an angle α formed by an axis O_{I} along which a main beam of an incident laser beam directed to the respective reflection surfaces of the polygon mirror 50 travels and an optical axis O_{R} of the focusing optical system 60 is 5° when the axis O_{I} and the optical axis O_{R} are projected on a main scanning plane (a horizontal reference plane). A scanning angle β is 26°. An angle γ (a predetermined angle) formed by an optical axis O_{P} of the pre-deflection optical system 40 and an optical axis O_{R} of the focusing optical system 60 is 34° when the optical axis O_{P} and the optical axis O_{R} are projected on the main scanning plane. Numerical values of the angles α, β, and γ are not limited and depend on a housing size of the optical scanning device and an arrangement layout of the respective components.

In order to completely separate optical paths of the pre-deflection optical system 40 and the focusing optical system 60 without applying an optical element for separation (e.g., a half mirror), the optical axis of the incident laser beam on the polygon mirror 50 and the optical axis O_{R} of the focusing optical system are arranged at an angle of 2° in a state in which the optical scanning device 21 is viewed from a sub-scanning section (FIG. 3B).

In the optical scanning device 21 shown in FIGS. 3A and 3B, a sectional beam shape of the divergent laser beam L radiated from the light source 41 is converted, by the lens 42, into a sectional beam shape of converging light, parallel light, or diverging light.

The laser beam L, the sectional beam shape of which is converted into a predetermined shape, is transmitted through the aperture 43 and a light beam width and a quantity of light thereof are optimally set. Predetermined converging properties are given to the laser beam L only in the sub-scanning direction by the cylindrical lens 44. Consequently, the laser beam L changes to a linear shape extending in the main scanning direction on the respective reflection surfaces of the polygon mirror 50.

The polygon mirror 50 is, for example, a regular dodecahedron. An inscribed circle diameter Dp thereof is, for example, 29 mm. When the number of reflection surfaces of the polygon mirror 50 is represented as N, the width Wp in the main scanning direction of the respective reflection surfaces (twelve surfaces) of the polygon mirror 50 can be calculated by the following formula:

Wp=tan(π/N)×Dp

In this example,

Wp=tan(π/12)×29=7.77 mm

On the other hand, a beam width DL in the main scanning direction of the laser beam L irradiated on the respective reflection surfaces of the polygon mirror 50 is about 32 mm and is set wide compared with the width Wp=7.77 mm in the main scanning direction of the respective reflection surfaces of the polygon mirror 50. As the beam width is larger in the main scanning direction, fluctuation in a quantity of light between scanning ends and a scanning center on an image surface is further reduced.

The laser beam L guided to the respective reflection surfaces of the polygon mirror 50 and continuously reflected to be linearly scanned (deflected) according to the rotation of the polygon mirror 50 is given with predetermined focusing properties by the focusing lens 61 of the focusing optical system 60 such that the sectional beam diameter thereof is substantially equal with respect to at least the main scanning direction on the photoconductive drum 23. The laser beam L is focused on the surface of the photoconductive drum 23 substantially linearly.

A rotation angle of the respective reflection surfaces of the polygon mirror 50 and a focusing position, i.e., a scanning position of the laser beam L focused on the photoconductive drum 23 are corrected by the focusing lens 61 to have a proportional relation. Therefore, the speed of the laser beam L linearly scanned on the photoconductive drum 23 is fixed in all scanning areas by the focusing lens 61. A curvature (a sub-scanning direction curvature) with which shift in a scanning position in the sub-scanning direction due to the influence of nonparallelism of the respective reflection surfaces of the polygon mirror 50 with respect to the sub-scanning direction, i.e., occurrence of toppling in the respective reflection surfaces can be corrected is given to the focusing lens 61. Moreover, an image surface curve in the sub-scanning direction is also corrected. In order to correct these optical characteristics, the curvature in the sub-scanning direction is changed according to a scanning position.

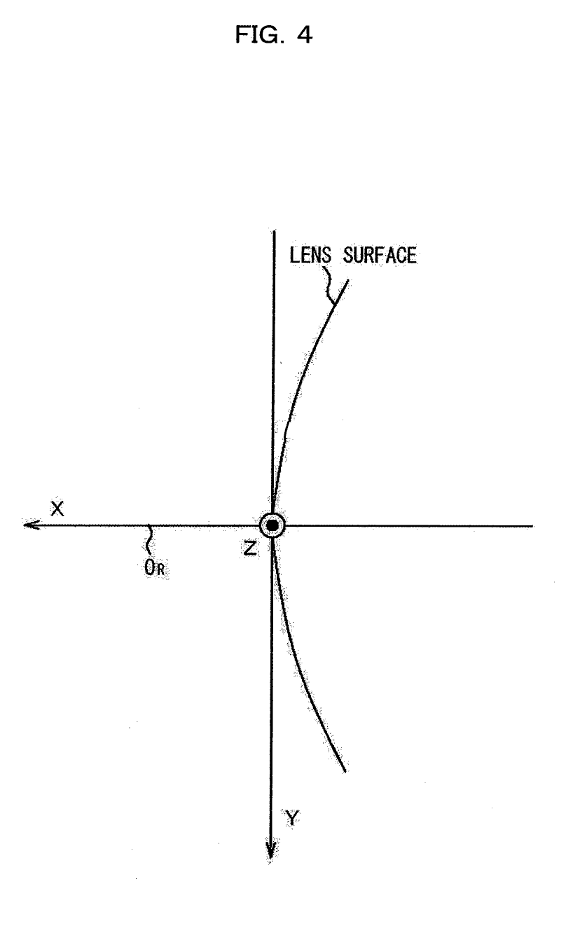

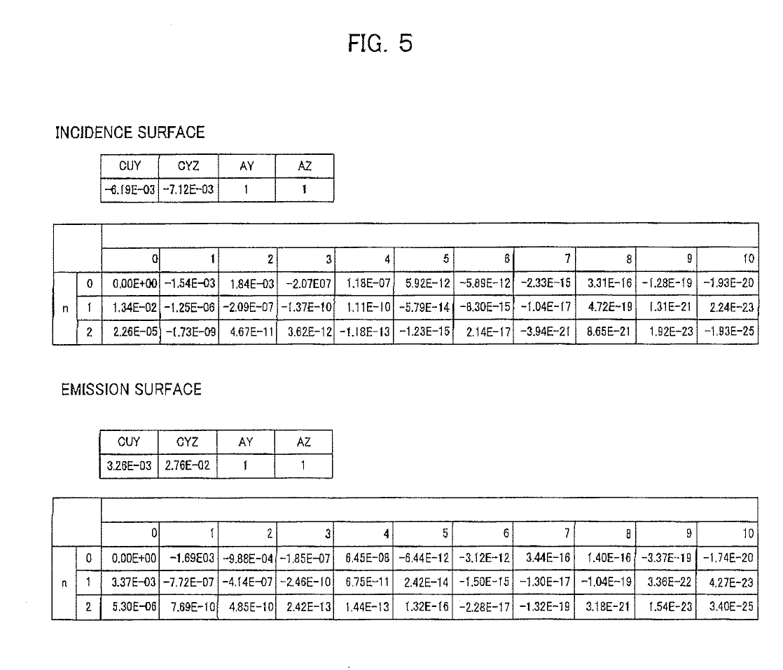

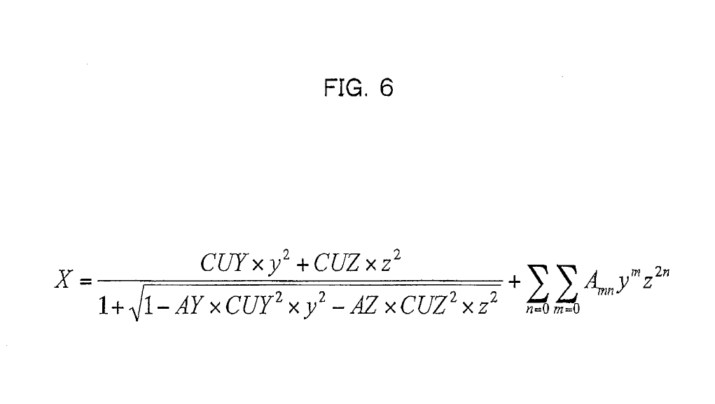

An example of a shape and a coordinate system of a lens surface of the focusing lens 61 is shown in FIG. 4. In the coordinate system in FIG. 4, a shape of the focusing lens 61 can be defined by parameters shown in FIG. 5 and a definition formula in FIG. 6.

By using such a focusing lens 61, a rotation angle θ of the respective reflection surfaces of the polygon mirror 50 and a position of the laser beam L focused on the photoconductive drum 23 have a generally proportional relation. Therefore, it is possible to correct a position of the laser beam L when the laser beam L is focused on the photoconductive drum 23.

The focusing lens 61 also makes it possible to correct positional shift in the sub-scanning direction caused by a deviation in a tilt in the sub-scanning direction among the respective reflection surfaces of the polygon mirror 50, i.e., fluctuation in an amount of surface toppling. Specifically, by setting a laser beam incidence surface (on the polygon mirror 50 side) and an emission surface (on the photoconductive drum 23 side) of the focusing lens 61 in a generally optically conjugate relation, even when a tilt defined between an arbitrary reflection surface of the polygon mirror 50 and a rotation axis of the polygon mirror 50 is different (for each of the reflection surfaces), it is possible to correct shift of a scanning position in the sub-scanning direction of the laser beam L guided on the photoconductive drum 23.

A sectional beam diameter of the laser beam L depends on a wavelength of the laser beam L radiated by the light source 41. Therefore, by setting the wavelength of the laser beam L to 650 nm or 630 nm or a shorter wavelength, it is possible to further reduce the sectional beam diameter of the laser beam L.

A mirror after deflection by the polygon mirror 50 is formed by a plane. In other words, surface toppling correction is performed by only an fθ lens.

A surface shape of the fθ lens may be, for example, that of a toric lens that has a rotationally symmetrical axis with respect to the main scanning axis and a curvature of which in the sub-scanning direction is different depending on a scanning position. Consequently, refracting power in the sub-scanning direction is different depending on a scanning position and it is possible to correct a bend of a scanning line. Moreover, when a curved surface in the sub-scanning direction has a rotationally symmetrical axis, a degree of freedom of a curvature in the sub-scanning direction increases and it is possible to more accurately correct the bend. Annular olefin resin (plastic) is used as a material of the fθ lens (the focusing lens 61).

FIGS. 7A and 7B are perspective views for explaining that, when a reflection surface is arranged to be inclined along a direction corresponding to the main scanning direction and a direction corresponding to the sub-scanning direction with respect to a light beam made incident on the folding mirror 45, a coordinate of the light beam reflected by the folding mirror 45 is rotated. In FIG. 7A, the reflection surface of the folding mirror 45 is arranged to be inclined by an angle ε only along the direction corresponding to the main scanning direction. In FIG. 7B, the reflection surface is inclined by an angle ζ along the direction corresponding to the sub-scanning direction (a normal of the horizontal reference plane) in addition to the direction in FIG. 7A. In FIG. 7B, when the direction corresponding to the main scanning direction of the light beam reflected by the folding mirror 45 and the direction corresponding to the sub-scanning direction are represented as a Y direction and an X direction with respect to the light beam made horizontally incident on the horizontal reference plane, it is seen that the Y direction and the X direction tilt with respect to the horizontal and vertical directions and a coordinate of the light beam is rotated by an angle δ.

Therefore, the pre-deflection optical system 40 in this embodiment is arranged horizontally with respect to the horizontal reference plane (i.e., the lens 42, the aperture 43, and the cylindrical lens 44, which are the components configuring the pre-deflection optical system 40, are arranged in parallel to the reference plane). The folding mirror 45 is arranged to have the angle ζ with respect to the normal of the horizontal reference plane. A plane perpendicular to the rotation axis of the polygon mirror 50 is arranged to be inclined by the angle θ with respect to the horizontal reference plane (concerning the angle θ, see FIG. 2, i.e. an axis inclined by the angle θ with respect to the normal of the horizontal reference plane is set as a rotation axis of the polygon mirror). Rotation distortion around the optical axis of the laser beam L is corrected by determining θ with which a rotation angle of a coordinate generated by the reflection of the laser beam L on the polygon mirror 50 is −δ with respect to a rotation angle δ of the coordinate generated by the reflection of the laser beam L on the folding mirror 45. According to this correction, it is possible to eliminate the influence of rotation of a coordinate in a laser beam after deflection.

In the optical scanning device 21 shown in FIGS. 3A and 3B and FIGS. 7A and 7B, the angle ζ formed by the folding mirror 45 along the direction corresponding to the sub-scanning direction is 0.35°. Consequently, a coordinate rotates around an axis of a laser beam of the pre-deflection optical system. By setting the angle θ formed by the plane perpendicular to the rotation axis of the optical scanning means with respect to the horizontal reference plane to 2.67°, the influence of the rotation of the coordinate is eliminated and a longitudinal direction (the Y direction) of the laser beam after deflection coincides with the main scanning direction.

Numerical values of the respective angles described above are not limited and are determined by performing a geometrical calculation on the basis of a size of the housing of the optical scanning device and an arrangement layout of the respective components.

This embodiment is applicable in both the under-illumination scanning optical system and the over-illumination scanning optical system. However, distortion more conspicuously occurs in the over-illumination scanning optical system. Therefore, in this embodiment, a further effect is realized in the over-illumination scanning optical system.

The present invention has been explained in detail with reference to the specific embodiment. However, it would be obvious for those skilled in the art that various alterations and modifications are possible without departing from the spirit and the scope of the present invention.

As described above in detail, according to the present invention, it is possible to correct rotation distortion around an optical axis of a light beam involved in a reduction in size of the housing.

Since the respective components configuring the pre-deflection optical system can be arranged in parallel to the horizontal reference plane, it is possible to more accurately arrange the components than a tilted arrangement.

What is claimed is:

1. An optical scanning device comprising:
a pre-deflection optical system that shapes a light beam emitted from a light source into a predetermined sectional shape;
optical scanning means for deflecting an incident light beam with plural reflection surfaces arrayed in a rotating direction and scanning the light beam on a scanning object; and
a folding mirror that deflects the light beam, which is shaped by the pre-deflection optical system, with a reflection surface and guides the light beam to the reflection surfaces of the optical scanning means, wherein
the reflection surfaces of the optical scanning means and the reflection surface of the folding mirror have a position relation for correcting rotation distortion around an optical axis of the light beam, which is shaped by the pre-deflection optical system, caused when the shaped light beam is deflected by the folding mirror.

2. An optical scanning device according to claim 1, wherein
components of the pre-deflection optical system are arranged in parallel to a reference plane, and
the reflection surface of the folding mirror is inclined with respect to a normal of the reference plane.

3. An optical scanning device according to claim 2, wherein the optical scanning means corrects the rotation distortion by setting an axis inclined with respect to the normal of the reference plane as a rotation axis of the optical scanning means.

4. An optical scanning device according to claim 2, wherein the components of the pre-deflection optical system are arranged such that projection on the reference plane of an optical axis of the light beam reflected by the optical scanning means when the scanning object and a single reflection surface of the optical scanning means are parallel and projection on the reference plane of an optical axis of the pre-deflection optical system form a predetermined angle.

5. An optical scanning device according to claim 1, wherein the light beam made incident on the optical scanning means has width wider than width in a scanning direction of a single reflection surface of the optical scanning means.

6. An optical scanning device according to claim 1, further comprising a focusing optical system that focuses the light beam scanned by the optical scanning means on the scanning object.

7. An optical scanning device according to claim 6, wherein the focusing optical system includes at least a plastic lens.

8. An optical scanning device according to claim 6, wherein the focusing optical system is a unit in which a lens and a mirror are integrally formed.

9. An optical scanning device according to claim 6, wherein the focusing optical system includes at least a toric lens.

10. An optical scanning device according to claim 1, wherein the pre-deflection optical system includes at least a cylindrical lens.

11. An image forming apparatus comprising:
an optical scanning device including:
a pre-deflection optical system that shapes a light beam emitted from a light source into a predetermined sectional shape;
optical scanning means for deflecting an incident light beam with plural reflection surfaces arrayed in a rotating direction and scanning the light beam on a scanning object; and
a folding mirror that deflects the light beam, which is shaped by the pre-deflection optical system, with the reflection surfaces and guides the light beam to a reflection surface of the optical scanning means,
the reflection surfaces of the optical scanning means and the reflection surface of the folding mirror having a position relation for correcting rotation distortion around an optical axis of the light beam, which is shaped by the pre-deflection optical system, caused when the shaped light beam is deflected by the folding mirror;
a photoconductive member on which an electrostatic image is formed by the light beam scanned by the optical scanning device; and
visualizing means for developing the electrostatic image formed on the photoconductive member.

12. An image forming apparatus according to claim 11, wherein
components of the pre-deflection optical system are arranged in parallel to a reference plane, and
the reflection surface of the folding mirror is inclined with respect to a normal of the reference plane.

13. An image forming apparatus according to claim 12, wherein the optical scanning means corrects the rotation distortion by setting an axis inclined with respect to the normal of the reference plane as a rotation axis of the optical scanning means.

14. An image forming apparatus according to claim 12, wherein the components of the pre-deflection optical system are arranged such that projection on the reference plane of an optical axis of the light beam reflected by the optical scanning means when the scanning object and a single reflection surface of the optical scanning means are parallel and projection on the reference plane of an optical axis of the pre-deflection optical system form a predetermined angle.

15. An image forming apparatus according to claim 11, wherein the light beam made incident on the optical scanning means has width wider than width in a scanning direction of a single reflection surface of the optical scanning means.

16. An image forming apparatus according to claim 11, wherein the optical scanning device further includes a focusing optical system that focuses the light beam scanned by the optical scanning means on the scanning object.

17. An image forming apparatus according to claim 16, wherein the focusing optical system is a plastic lens.

18. An image forming apparatus according to claim 16, wherein the focusing optical system is a unit in which a lens and a mirror are integrally formed.

19. An image forming apparatus according to claim 16, wherein the focusing optical system is a toric lens.

20. An image forming apparatus according to claim 11, wherein the pre-deflection optical system includes at least a cylindrical lens.
